(19) United States
(12) Patent Application Publication
(10) Pub. No.: US 2019/0343300 A1
(43) Pub. Date: Nov. 14, 2019

(54) SERVING SYSTEM AND SENSOR DEVICE FOR PICK-AND-MIX SALES

(71) Applicant: Mixmoose AB, Ljungsarp (SE)

(72) Inventors: Fredrik Junkell, Ljungsarp (SE); Thomas Åberg, Mölndal (SE)

(73) Assignee: Mixmoose AB, Ljungsarp (SE)

(21) Appl. No.: 16/482,662

(22) PCT Filed: Jan. 31, 2018
(86) PCT No.: PCT/EP2018/052404

§ 371 Date: Jul. 31, 2019

(30) Foreign Application Priority Data
Jan. 31, 2017 (SE) 1750077-8

(51) Int. Cl. A47F 1/035; G01F 23/26; G01F 25/00

(52) U.S. Cl. CPC A47F 1/035; G01F 25/0084; G01F 23/263

(57) ABSTRACT

A sensor device (8, 15, 20) for monitoring the volume of granular food or candy contained in a pick-and-mix container (2), wherein the sensor device (8, 15, 20) comprises at least one pair of electrodes (10, 11), a capacitance meter (12) and a controller (13). The capacitance meter (12) is connected to the at least one pair (9, 16) of electrodes (10, 11, 17, 18) and operable to measure the capacitance over the at least one pair (9, 16) of electrodes (10, 11, 17, 18) to produce an output indicative of the capacitance through the container (2). The controller (13) is operable to determine and report a content level of the container (2) based on at least the output of the capacitance meter (12) and calibration data related to the type of container and/or to the type of content, and/or operable to monitor the output of the capacitance meter (12) to determine a state of low content level based on at least the output of the capacitance meter (12) and calibration data related to the type of container and/or to the type of content, and to emit an alert signal upon determination of said state of low content level.

### TECHNICAL FIELD

The present invention relates to dispensers for granular food such as candy, nuts, granola, rice and beans. Such dispensers are typically found in grocery stores, cinemas, and convenience stores for providing a means for the customer to pick and choose among several sorts of granular food, exactly the sorts and amounts he or she prefers. This is an alternative to providing the products in standardized packages with predetermined amounts of a specific selection of product in each package.

### BACKGROUND

In some countries it is common that the stores provide a means for the customer to buy granular food by weight rather than in packages containing a standardized weight and selection of product. For example, this is very common in Sweden where candy is sold in a display or serving system from which many types of candy can be picked by a customer using a scoop to pick the types and amounts of candy he or she wants, put those in a bag, weigh the bag and pay for the candy picked. Each customer can thus leave the store with a customized selection of candy.

The candy is delivered to the store in square plastic boxes sealed with removable lids and stacked on wooden pallets. There are usually many different types of candy in each shipment and it is challenging for the store personnel to keep track of the various boxes over time.

Several display or serving systems exist. A basic way for a store to serve the candy to customers is to leave the candy in the plastic boxes shipped to the store and simply remove the lid and place a number of such packages for display on a table or shelf in the store. A drawback of this serving system is that it requires much shelf or table space. A further drawback is that the quantity of candy of each package on display is quite small and thus quickly runs empty. Also, some types of candy may need frequent refill whilst some types of candy may need refill less frequently and hence the store personnel have to frequently walk about the store to inspect the levels of remaining products on display and refill or change the packages as needed. Whenever a package on display runs empty there is a risk that the sales of candy decreases and revenue is lost for the store owner. Also, running empty on specific types of candy on display may lead to disappointed customers whenever the customer is looking for such a specific type of candy and cannot readily find it. A further challenge of this basic serving system is contamination of the packages on display by dust, sneezing customers, and poking fingers. Also, there is a risk that the scoops used to pick candy are dropped on the floor or otherwise contaminated such that the scoops contaminate the candy picked and the candy on display.

Some stores use special display containers rather than serving the candy in the containers in which the candy was shipped to the store. Such special display containers may be bigger bowls or boxes into which the content of several primary packages is poured, typically only one type of candy in each such special display container. The larger maximum quantity of candy on display allowed by the special display container as compared to the shipping package thus prolongs the time is takes for the container to run empty and thus reduces the risk of the display container running empty. This allows for less frequent inspection of the levels contained in the serving containers on display as compared to when using the smaller packages in which the candy was shipped to the store, as described above.

Alternatively, some stores use wall or rack mounted containers for display of the candy. These containers may comprise transparent portions such that the candy is visible through the container. Alternatively, the container may comprise an attached illustration or photo showing its content. The customer can easily determine the type of candy contained and pick his/hers candy types of choice. Store personnel walk to each respective container to visually inspect the level of candy left in the container. Wall or rack mounted candy containers often have a lower compartment provided with an opening configured such that candy is accessible for being picked by the customer through the opening. Also wall mounted containers are often provided with an upper compartment extending upwards from the lower compartment to increase the storage capacity of the container. A lower portion of the upper compartment is open into the lower compartment such that candy inside the upper compartment can move into the lower container by the force of gravity upon candy being picked from the lower compartment. The upper and lower compartments may be of uni-body design or assembled from sub-components. The wall or rack mounted containers are often mounted in an array with several containers side-by-side forming levels, and several such levels of containers mounted above one another on the rack or wall. Thus, an advantage of wall or rack mounted candy containers is that more types of candy or granular food can be displayed using less floor area as compared to using containers placed on tables or shelves as previously described.

Yet another serving system is a type of wall or rack mounted container provided with a mechanical or electro-mechanical feeding system (‘fed containers’) configured to feed candy from within the container and out through an outlet, preferably into a bag or receptacle held by the customer picking the items of candy or granular food. One such system is described in European patent EP2787863B1. Containers provided with feeding mechanisms bring the advantage over the above described containers without feeding mechanisms in that the fed containers are not dependent on gravity in order to feed the content through the container for being picked, which in turn enables more flexibility as to how the container extends in space since the granular food or candy can be fed horizontally and/or upwards. This means that there is no need of an upper storage compartment. Hence, the fed containers allow for more types of candy to be stored and displayed using a given wall- or rack surface since the containers/dispensers may be designed to extend horizontally inwards into the wall or rack, away from the wall- or rack front, which in turn enables design of containers with smaller front area as compared to non-fed containers. Generally, such fed containers or dispensers are stacked or mounted closely to one another to save store space. An advantage of this type of serving system with fed containers, also known as dispensers, is that candy can be dispensed straight into the bag or receptacle rather than having to be moved from the container to the bag or receptacle by hand or using a scoop, which in turn reduces the risk of contamination by the scoop and enables better protection of candy stored inside the container to keep people from sneezing or breathing into the containers.

Bulk confectionary, penny candy and loose candy are all names for the same concept applied specifically to candy or confectionary. A broader term used to refer to the above described display systems is “pick-and-mix”.

A drawback of the all the above described serving systems for display and serving or dispensing of granular food or candy is that the containers repeatedly must be manually inspected to determine the level of content left inside individual ones of the respective containers such that they can be refilled as needed. Inspection takes time, occupies the personnel, and thus drives cost.

Therefore, there is a need of improved serving systems not suffering from the above described drawbacks.

### SUMMARY

An object of the invention is to provide an improved serving system for items of granular food or candy, which mitigates the drawbacks discussed above.

According to a first aspect of the invention, this and other objects are achieved by a sensor device for monitoring the volume of granular food or candy contained in a pick-and-mix container, wherein the sensor device comprises at least one pair of electrodes, a capacitance meter and a controller. The capacitance meter is connected to the one or more pairs of electrodes and operable to measure the capacitance over the at least one pairs of electrodes to produce an output indicative of the capacitance through the container. The controller is operable to determine and report a content level of the container based on at least the output of the capacitance meter and calibration data related to the type of container and/or to the type of content, and/or operable to monitor the output of the capacitance meter to determine a state of low content level based on at least the output of the capacitance meter and calibration data related to the type of container and/or to the type of content, and to emit an alert signal upon determination of said state of low content level.

The pair(s) of electrodes can measure capacitance through a portion of a container. Items of granular food or candy within the container affect capacitance between the electrodes in each pair, giving higher capacitance at higher volumes of items in the container and likewise lower capacitance at lower volumes of items in the container. This in turn enables electronic inspection of the volume/level of items contained. The capacitance for any given volume or level of content in the container varies with type of content of the container. Also, the form and material or the container greatly affects the capacitance reading for any given volume/level contained. By using calibration data related to the type of container and/or to the type of content for determining the volume/level determined, accurate determination is possible for any type of content and for any type of container used. This enables the sensor system to be used for any type of content and for many types of containers without modification.

The sensor device may comprise two pairs of electrodes. In other words, said at least one pair of electrodes in such an embodiment comprises at least two pairs of electrodes.

The provision of two pairs of electrodes enables measurement of capacitance in two separate portions of the pick-and-mix container. By being able to measure capacitance in two portions of the container, any uneven distribution of candy between the portions can be taken into account then determining the volume of granular food or candy contained. This improves accuracy and is important in pick-and-mix systems where the distribution of content in the container is affected by customers picking by hand, or affected by a feeding mechanism moving said content within the container.

The at least two pairs of electrodes may share at least one mutual electrode. By having a mutual electrode, the capacitance of two different container portions, typically portions of two containers positioned side-by-side, can be measured using one mutual electrode positioned between the containers rather than using two intermediate electrodes—one for each pair. If more than two containers are positioned in line side-by-side, such as in a typical wall hung pick-n-mix system, single mutual electrodes could be used between all containers and only the outer electrodes in each respective end of the line of containers would need to be plain/‘non-mutual’ electrodes useful only for measurement through one container. The use of at least one mutual electrode thus enables a great decrease in the number of electrodes needed to enable measurement in a line of containers positioned side-by-side.

The at least two pairs of electrodes may be connected in parallel such that the meter is operable to jointly measure the capacitance in the at least two pairs of electrodes. By connecting the electrodes in parallel, one capacitance reading is directly obtained for the average capacitance of the container portions. The parallel connection provides a quick and easy way of obtaining a capacitance value indicative of the volume of content in the container even though the content would be unevenly distributed within the container.

As an alternative to parallel connection, the meter may be operable to separately measure capacitance between the electrodes in each respective pair of electrodes and account for the characteristics of each respective pair of electrodes at production of said output of the meter.

By separately measuring the capacitance it is possible for the sensor device to account for variations in size and shape of the respective electrode pair when performing calculations for establishing the output of the meter. This enables use of electrodes of different size and shapes and makes the sensor device suitable also for containers of varying size and shape.

The capacitance meter may be configured to use a plurality of capacitance readings to calculate an average and base the meter output on the calculated average. By using a plurality of capacitance readings, natural variations in measured capacitance are evened out, for example variations due to new orientations of the pieces of content contained without substantial variation in contained volume/level. The orientation of pieces contained tend to change when a customer picks content or when a dispensing device moves content within the container.

The controller being may be configured to temporarily disable capacitance measurement in response to an input signal indicative of the running state of a nearby electric motor, wherein capacitance reading is disabled when the input signal indicates the motor is running, and wherein the determination is enabled when the input signal indicates the motor is not running. When a nearby electric motor is running, such as the motor of a feed mechanism of the container, the capacitance measurements are disturbed.

The electrodes may comprise metal foil or tape connected to the capacitance measuring device.

Metal is a good conductor of electricity and thus suitable for use as electrode. Using foil or tape as electrode allows for a very thin sheet-like design of the electrodes, which is space saving and thus enables installation of the sensor device between adjacent containers where only very limited amounts of space is available. Examples of suitable metals are copper or aluminum.

The excellent electrical conductivity of copper and aluminum enables production of thin and light electrodes, enabling installation of the sensor device where little space is available, such as between adjacent containers already installed in a store.

The electrodes may be substantially planar and comprise a respective bottom portion and a respective top portion, said bottom and top portions being foldable such that the bottom portion extends substantially perpendicularly to the top portion. The bottom portion can thus be placed under the container whilst the top portion at the same time can extend substantially vertically along the container. This brings an advantage in that the weight of the container can be utilized to keep the electrode in a fixed position by squeezing the lower portion of the electrode between the container and the surface on which the container is supported. Thus, any need of adhesive between container and electrode is mitigated such that no adhesive or less adhesive can be used. Further, the upper portion of the electrode can thus rest between containers placed side-by-side without need of adhesive to keep the electrode from falling away from the container.

The sensor device may further comprise a light source operable to emit light for visually indicating low content in the container. The controller is configured to activate the light source upon determining that the volume of granular food or candy contained is below a predetermined threshold value.

The light source provides a convenient means to signal that the container needs refilling. The light source can be noticed at a distance from the serving device by store personnel and hence the personnel do not necessarily have to walk up to the serving device to inspect it.

Another aspect of the invention relates to a serving system comprising a sensor device as described above. The system also comprises the container described above in relation to the sensor device. The electrodes of each respective pair of electrodes are provided on opposite sides of the container for measuring capacitance through the container. Each pair of electrodes can measure thus capacitance through a portion of the container. Items of granular food or candy within the container affect capacitance between the electrodes in each pair, giving higher capacitance at higher volumes of items in the container and likewise lower capacitance at lower volumes of items in the container. This in turn enables electronic inspection of the volume of items contained.

Alternatively, a serving system is provided comprising a sensor device comprising two pairs of electrodes as also described above. The system also comprises the container described above in relation to the sensor device. The electrodes of each respective pair of electrodes are provided on opposite sides of the container for measuring capacitance through the container. Further, the pairs of electrodes are positioned apart from each other for measuring capacitance through different portions of the container. Each pair of electrodes can measure thus capacitance through a portion of the container. Items of granular food or candy within the container affect capacitance between the electrodes in each pair, giving higher capacitance at higher volumes of items in the container and likewise lower capacitance at lower volumes of items in the container. This in turn enables electronic inspection of the volume of items contained. By being able to measure capacitance in two different portions of the container, any uneven distribution of candy between the portions can be taken into account then determining the volume of granular food or candy contained. This improves accuracy and is important in many pick-and-mix systems where the customers, or a feeding mechanism, tend to move around the content during picking or dispensing thereby bringing the content out of level.

The electrodes may by attached directly onto the outside of the container. For example by means of adhesive, hook-and-loop fastener, rivets, screws, push buttons.

Attaching the electrodes directly onto the outside of the container is advantageous since it ensures that the reading is always performed on the same portion of the container and without accidental variation of a gap between container and electrode. A varying gap between container and electrode would affect the readings for a given volume of content and would thus result in erroneous volume calculations, deviating from calibrated values. Further, varying position of the electrode relative to the container, would render calculations based on two or more pairs of electrodes whose relative location is known, inaccurate or wrong. Also, attaching the electrodes onto the outside of the container ensures that the electrodes are not exposed to wear and tear by a picking scoop or hard pieces of content moving around inside the container.

A further aspect of the invention relates to a method of calibrating the serving systems described above for a specific type of content. The method comprises the steps of for a plurality of different fill levels of the container operating the capacitance meter to record for each fill level reference values for the capacitance for each respective pair of the second and/or first pair of electrodes, and based on the recorded values prepare calibration data related to the type of container and/or to the type of content, such that the calibration data relates capacitance values to a contained content level for the specific type of container and/or to the type of content used for performing the method.

Such a method enables a sensor device of the system to be used with containers of varying size and shape, as well as with all sorts of granular food or candy, since the sensor device can easily be calibrated and recalibrated by the store in which it is used.

Another aspect of the invention relates to a computer readable storage medium encoded with instructions that, when executed on a processor, perform the above-described calibration method.

Table of reference numerals

| | |
|---|---|
| 1 | serving system, first embodiment |
| 2 | container |
| 3 | front opening |
| 4 | lid |
| 5 | lower compartment |
| 6 | upper compartment |
| 7 | upper opening |
| 8 | sensor device, first embodiment |
| 9 | first pair of electrodes |
| 10 | first electrode in first pair |
| 11 | second electrode in first pair |
| 12 | capacitance meter |
| 13 | controller |
| 14 | light source |
| 15 | sensor device, second embodiment |
| 16 | second pair of electrodes |
| 17 | first electrode in second pair |
| 18 | second electrode in second pair |
| 19 | serving system, second embodiment |
| 20 | sensor device, third embodiment |

### DETAILED DESCRIPTION

The disclosed embodiments will hereinafter be described in more detail with reference to the accompanying drawings in which some embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art. Like numbers refer to like elements throughout.

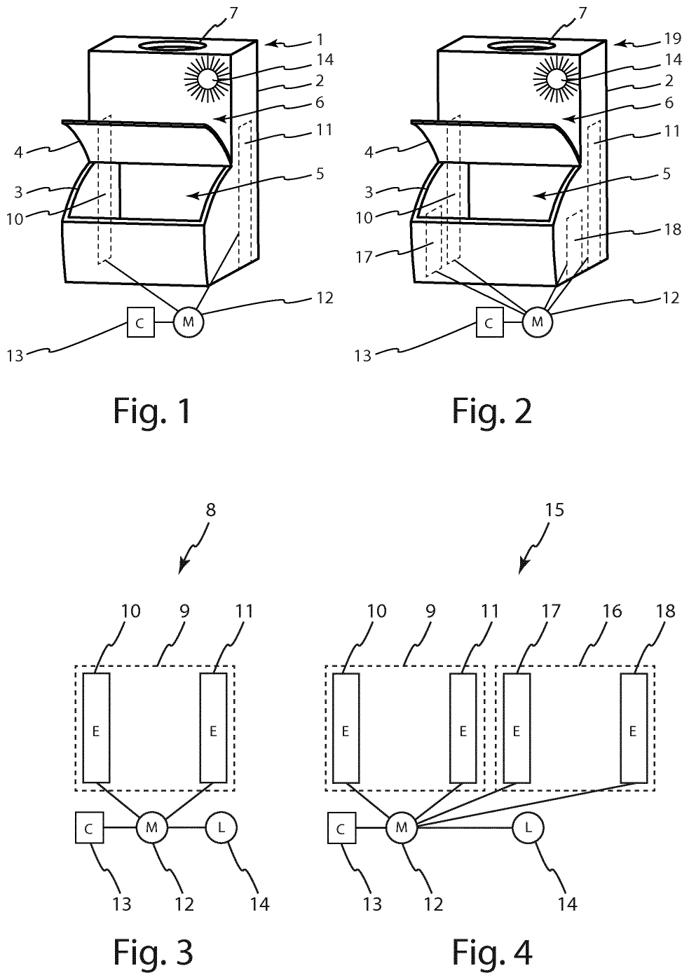

FIG. 1 shows a serving system 1 according to a first embodiment of the invention. The serving system comprises an empty pick-and-mix container 2. A pick-and-mix container is any container suitable for being used in a pick-and-mix environment in a store. The container 2 shown is of a known wall or rack mounted type as described in the background. The container 2 has a body of clear plastic and is provided with a front opening 3 covered by a lid 4 attached to the body by a hinge means such that it can be readily opened and closed. A suitable material for the container 2 is PMMA, commonly known as acrylic glass, although other materials are possible as long as they allow for capacitive measurement through the container 2.

The container 2 has a lower compartment 5 provided with the front opening opening 3 configured such that candy is accessible for being picked by a customer through the front opening 3. The container 2 also has an upper compartment 6 extending upwards from the lower compartment 5 to increase the storage capacity of the container 2. A lower portion of the upper compartment 6 is open into the lower compartment 5 such that candy inside the upper compartment 6 can move into the lower compartment 5 by the force of gravity upon content being picked from the lower compartment 5. In some embodiments (not shown), the lower back of the container 2 is forwardly slanted for items of content to be forced forwards in the container by gravity towards the lower opening 3.

The container 2 shown is preferably filled through its upper opening 7 and emptied through the front opening 3. The upper opening 7 may in other embodiments be provided with a lid (not shown) to protect it from dust and contamination.

The serving system 1 further comprises a sensor device 8 also shown separately in FIG. 3. The sensor device 8 comprises a pair 9 of electrodes 10, 11. The pair 9 of electrodes 10, 11 are provided on opposite sides of the container 2 for measuring capacitance through the container 2. The electrodes 10, 11 are adhesive copper tape applied directly onto the outside of the container 2. Another feasible electrode material is aluminum. Instead of using tape, various forms of foils or plates could be used as electrodes. The distance between container 2 and electrode 10, 11 should preferably be kept low and static since any gap affects the capacitance readings made.

The sensor device 8 also comprises a capacitance meter 12 and a controller 13. The capacitance meter 12 is connected to the pair 9 of electrodes 10, 11 and operable to measure the capacitance over the electrodes 10, 11 to produce an output indicative of the capacitance through the container 2.

The capacitance meter 12 comprises a Smartec Universal Transducer Interface IC, although other metering components/ICs are feasible within the scope of the present invention. The Smartec Universal Transducer Interface is operable to measure several capacitances simultaneously using MUX, which enables several containers 2 to be monitored by a single sensor device using only one IC.

People operating the serving system 1 may be interested in detailed continuous information of the content level in the container 2.

The term “content level” is here used broadly to refer to any suitable measurement reference system of choice. For example, a reference system may be continuous such as percentage of current volume contained vs maximum volume contained. Alternatively, it may be discrete, such as having a plurality of named levels: ‘Full’, ‘Nearly full’, ‘Nearly empty’ and ‘Empty’ or similarly numeric levels 1, 2, 3 and 4. Further, the content level could refer to the specific current volume contained, without relating it to the maximum volume that the container 2 can contain. Alternatively, it could describe the approximate weight of product contained.

For example, one may be interested in the current content level to be able to know how much product need be taken from back-office/a warehouse, loaded onto a cart and brought out into the store to refill the containers 2 containing a specific type of product. Preferably only one walk into the store to refill the containers is necessary. By knowing the current content level, the risk of bringing too much or too little new product from back-office into the store is reduced. Altogether, the continuous information saves precious time for the store personnel.

One may also be interested in tracking the content level over time in order to effortlessly be able to derive picking rates and predict when a specific container is likely to run empty or predict the expected content level in a container at a specific point of time. If personnel are scheduled to refill the containers at a specific time, it would be advantageous to be able to know what types of content they should bring to the store and how much should be brought from back-office to the store. The amount needed for refill at a specific time in the future can be calculated using the current levels and applying the knowledge of predicted picking rates gained by historic tracking of content levels.

To be able to continuously track the content level the controller 13 may in some embodiments be configured such that it is operable to determine and report a content level of the container 2 based on at least the output of the capacitance meter 12 and calibration data related to the type of container 2 and/or to the type of content.

In other use cases where continuous or on demand information is not of interest, it may for some embodiments suffice to configure the controller 13 such that it is operable to monitor the output of the capacitance meter 12 to determine a state of low content level based on at least the output of the capacitance meter 12 and calibration data related to the type of container 2 and/or to the type of content, and to emit an alert signal upon determination of said state of low content level.

In the embodiment depicted in FIG. 1, the controller 13 is configured to do both; ie. to determine and report a content level, and to monitor and determine a state of low content and emit an alert signal when the low level is detected.

As the skilled person will understand, there are many ways in which to configure a sensor device 8, 15, 20 to report a content level of the container 2 based on at least the output of its capacitance meter 12 and calibration data related to the type of container 2 and/or to the type of content. This will be discussed in more detail below.

What we want to achieve is to establish the relationship between capacitance and volume contained and save this information for use in operation of the sensor device. Basically, calibration of the sensor device 8, 15, 20 means that we have to study the capacitance through the container 2 for a plurality of known volumes of content in the container 2 and use the results of the study to establish a mathematical model for the relationship, or establish a look-up table for the relationship.

### EXAMPLE

### Deriving Calibration Data

A new sensor device 15 is unpacked for attachment to an existing container 2. Then, the electrodes 10, 11, 17, 18 of each respective pair 9, 16 of electrodes 10, 11, 17, 18 of the sensor device 15 are attached to opposite sides of the container 2 for measuring capacitance through the container 2. The electrodes 10, 11, 17, 18 may be provided with self-adhesive backing such that attachment is easy and does not require tools. The sensor device 15 is then connected to a power source (not shown), such as a wall outlet, battery or photovoltaic panel. Thereafter, the container 2 is filled with the specific content type of choice. Subsequently, the sensor device 15 is put in a calibration mode, such as by pushing a physical button or operating a software-implemented user interface. Thereafter, the container 2 is gradually emptied wherein the sensor device 15 records a capacitance measurement for each ‘fill-level’, either continously or in a number of discrete steps. The sensor device 15 is informed, directly or indirectly, of the decrease in content during emptying, so that the sensor device 15 can keep track of what the capacitance measurement(s) is/are for a specific volume/weight/fill-height of content.

One way of informing the sensor device 15 of the decrease in content is to remove content batchwise in known discrete steps, for example with a full scoop of candy in each step, such that the sensor device 15 can detect the sudden change of capacitance upon removal of content. Such automatic detection would constitute such indirect information. Alternatively direct information is used, wherein a person pushes a physical button or operates a computer implemented graphical user interface to tell the sensor device 15 that a decrease in contained volume has occurred. An alternative way of informing the sensor device 15 would be to remove content in constant known pace until empty, for example using a specially developed electromechanical feeding device for feeding content out of the container 2. When the removal rate is known, for example by measuring the time it takes for the feeding mechanism to fully empty the container 2, and knowing the volume of the container 2, it is possible to simply make capacitance measurements continously in regular interval and note the time elapsed.

Using any of the above mentioned discrete or continous emptying processes, it is thus possible to derive the calibration data needed for future use of the sensor device 15 for measuring the level of content in the container 2.

Upon each measurement, the capacitance meter 12 of a sensor device 15 activates a pair 9, 16 of electrodes 10, 11, 17, 18 in order to measure capacitance between them within the pair. The capacitance meter 12 outputs a measurement value or a series of measurement values over time. The capacitance meter 12 is typically capable of making a plurality of measurements and report an average value.

It should be understood that the capacitance, and hence the measurement value, will be different for a given level of content in the container 2 depending on the type of content. For example, measurements on a half-full container 2 will typically render different measurement values for different types of content, ie. different capacitance for different types of candy.

FIG. 6 shows capacitane measured for varying amounts of content of a container with the same type of content for all measurement values. For each volume, two values are plotted—one for a first pair of electrodes attached to a front portion of the container to measure capacitange through the front portion of the container, and another value for a second pair of electrodes attached to a back portion of the container for measuring capacitance through a back portion of the container. The capacitance variance between front and back of the container indicates that the content is not evenly distributed throughout the container. For this type of content, the relation between capacitance and volume follows a roughly linear curve with some amount of standard deviation. For other content types, the relation may exhibit a ‘bent’ or curved relationship rather than a linear, which would then be possible to approximate by an nth degree function, such as a quadratic or qubic function, such that said function could be used to derive a volume based on a capacitance measurement. Once a suitable function with suitable function parameters are found, this information stored as ‘calibration data’ along with information on type of content and possibly also along with information on type of container used for calibration. For example, one may be interested in knowing the type of container used for obtaining the calibration data in cases where tests have shown there is an important individual variance in how much specific containers of a given type affect capacitance measurements. In other cases, the individual containers shows not to affect capacitance reading much, wherein the container data may be less useful and omitted.

There are many ways in which the low level state can be communicated to people or computer systems. For example, a wired or wireless alert signal could be sent to a personal computer, smartphone or to a server storing or relaying the information as needed. A basic and intuitive way of communicating a state of low content level of a container 2 is achieved by the serving system 1 shown in FIG. 1 which uses the sensor device 8 shown in FIG. 3. The serving system 1 comprises a light source 14 for visually indicating low content in the container and the controller 13 is operable to activate said light source 14 to emit light in response to said alert signal indicating low content. Thus, store personnel can relax as long as the light source 14 is not lit and return to refill the container 2 once the light source 14 is lit. Instead of a light source, a personal computer or handheld computing device, such as a phone or tablet, could be used for communicating the alert. Alternatively, the controller could be configured to trigger sending of digital message, such as an email, an SMS, an MMS, or a Push Notification, to one or more recipients in order to alert them.

It should be understood that depending on refill strategy, low level state should not always be determined at the same content level or capacitance for all containers and content types. For example, more popular content types may need to be refilled more often, and as a result may need to send the alert signal earlier than what would be needed for less popular content types and times of day/week. Thus, the sensor device 8 may be configured to determine low level state at least partly based on content type and scheduled demand in addition to capacitance.

Also, it should be understood that the invention is not limited to this type of container 2 but could also be used with other types of containers suitable for the pick-and-mix concept. For example, the container could be the dispenser/container described in European patent EP2787863 which features an electromechanical feeding mechanism comprising a conveyor screw extending through the content of the container. The conveyor screw is made of metal and rotational orientation affects capacitance readings. Further, the action of the conveyor screw results in unevenly distributed content within the container, which also tends to affect capacitance readings through the container.

In order to mitigate the problems associated with disturbances from the electrical motor driving the feeding mechanism it is proposed to in some embodiments configure the controller 13 to temporarily disable capacitance measurement in response to an input signal indicative of the running state of a nearby electric motor, wherein capacitance measurement is disabled when the input signal indicates the motor is running, and wherein the capacitance measurement is enabled when the input signal indicates the motor is not running.

A second embodiment of a serving system according to the invention is shown in FIG. 2. The second embodiment of the serving system differs from the first embodiment in that it uses an alternative sensor device 15 shown separately in FIG. 4. The alternative sensor device 15 differs from the first sensor device 15 in that is comprises two pairs 9, 16 of electrodes instead of one pair 9 of electrodes. The provision of two pairs 9, 16 of electrodes enables measurement of capacitance in two separate portions of the pick-and-mix container 2, here a back portion and a front portion. By being able to measure capacitance in two portions of the container 2, any uneven distribution of content between the portions can be taken into account then determining the content level of granular food or candy contained. This improves accuracy and is important in pick-and-mix systems where the distribution of content in the container 2 is affected by customers picking by hand, or affected by a feeding mechanism moving said content within the container 2.

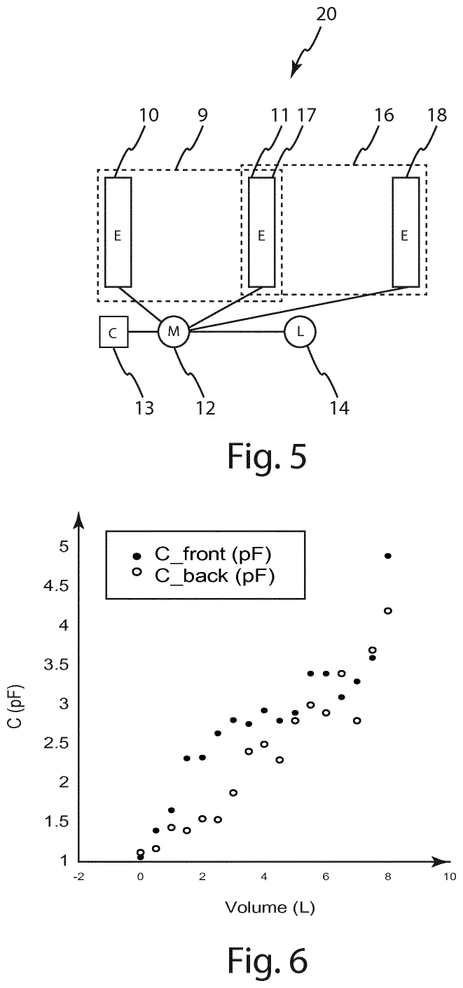

FIG. 5 shows a schematic view of a sensor device 20 according to an embodiment of the invention in which the sensor device 20 comprises two pairs 9, 16 of electrodes sharing a mutual electrode 11, 17. Such a sensor device 20 may be used for capacitance measurement through two containers (not shown) positioned side-by-side. The use of a mutual electrode 11, 17 thus enables a great decrease in the number of electrodes needed to enable measurement in a line of containers positioned side-by-side. The mutual electrode 11, 17 may have the same design as any other electrode and what makes it a mutual electrode 11, 17 is rather the configuration of the capacitance meter 12 which has to be made such that the meter 12 can selectively use the mutual electrode 11, 17 for measurements in different pairs 9, 16 of electrodes.

The controller 13 may be implemented using instructions that enable hardware functionality, for example, by using executable computer program instructions in a general-purpose or special-purpose processor that may be stored on a computer-readable storage medium (disk, memory, etc.) to be executed by such a processor. The controller 13 is configured to read instructions from the memory and execute these instructions to control the operation of the sensor device 1 including, but not being limited to the above described functions. The controller 13 may be implemented using any suitable, publicly available processor or Programmable Logic Circuit (PLC). The memory may be implemented using any commonly known technology for computer-readable memories such as ROM, RAM, SRAM, DRAM, FLASH, DDR, SDRAM or some other memory technology.

The computer-readable medium may be a data disc (not shown). In one embodiment the data disc is a magnetic data storage disc. The data disc is configured to carry instructions that when loaded into a controller 13, such as a processor, execute a method or procedure according to the embodiments disclosed above. The data disc is arranged to be connected to or within and read by a reading device, for loading the instructions into the controller 13. One such example of a reading device in combination with one (or several) data disc(s) is a hard drive. It should be noted that the computer-readable medium can also be other mediums such as compact discs, digital video discs, flash memories or other memory technologies commonly used. In such an embodiment the data disc is one type of a tangible computer-readable medium.

The instructions may also be downloaded to a computer data reading device, such as the controller 13 or other device capable of reading computer coded data on a computer-readable medium, by comprising the instructions in a computer-readable signal which is transmitted via a wireless (or wired) interface (for example via the Internet) to the computer data reading device for loading the instructions into a controller 13. In such an embodiment the computer-readable signal is one type of a non-tangible computer-readable medium.

The instructions may be stored in a memory of the computer data reading device.

References to computer program, instructions, code etc. should be understood to encompass software for a programmable processor or firmware, such as the programmable content of a hardware device whether instructions for a processor, or configuration settings for a fixed-function device, gate array or programmable logic device.

The inventive technology is not only to be provided as a serving system 1 comprising a container shipped with sensors and electronics, but also as a so called sensor device for retrofitting to existing pick-and-mix systems to convert them to into smart systems. FIGS. 3 and 4 show a first and a second embodiment of a sensor device according to the invention. The first embodiment of sensor device corresponds to the one used in the serving system 1 depicted in FIG. 1. The second embodiment of sensor device corresponds to the one used in the serving system 19 depicted in FIG. 2.

As mentioned, the invention has been described herein with reference to a few embodiments. However, as is readily appreciated by a person skilled in the art, other embodiments than the ones disclosed above are equally possible within the scope of the invention, as defined by the appended patent claims.

1. A sensor device
for monitoring the volume of granular food or candy contained in a pick-and-mix container,
wherein the sensor device comprises
at least one pair of electrodes,
a capacitance meter connected to the at least one pair of electrodes and operable to measure the capacitance over the at least one pair of electrodes to produce an output indicative of the capacitance through the container, and
a controller operable to determine and report the content level of the container based on at least the output of the capacitance meter and calibration data related to the type of container and/or to the type of content,
and/or
operable to monitor the output of the capacitance meter to determine a state of low content level based on at least the output of the capacitance meter and calibration data related to the type of container and/or to the type of content, and to emit an alert signal upon determination of said state of low content level.

2. A sensor device according to claim 1, wherein said at least one pair of electrodes comprise at least two pairs of electrodes.

3. A sensor device according to claim 2, wherein said at least two pairs of electrodes share at least one mutual electrode.

4. A sensor device according to claim 2, wherein the at least two pairs of electrodes are connected in parallel such that the meter is operable to jointly measure the capacitance in the at least two pairs of electrodes.

5. A sensor device according to claim 2, wherein the meter is operable to separately measure capacitance between the electrodes in each respective pair of electrodes and account for the characteristics of each respective pair of electrodes at production of said output of the meter.

6. A sensor device according to claim 1, wherein the capacitance meter is configured to use a plurality of capacitance measurements to calculate an average and base the meter output on the calculated average.

7. A sensor device according to claim 1, said controller being configured to temporarily disable capacitance measurement in response to an input signal indicative of the running state of a nearby electric motor, wherein capacitance measurement is disabled when the input signal indicates the motor is running, and wherein capacitance measurement is enabled when the input signal indicates the motor is not running.

8. A sensor device according to claim 1, wherein said electrodes comprise metal foil or tape connected to the capacitance measuring device.

9. A sensor device according to claim 8, wherein said metal is copper or aluminum.

10. A sensor device according to claim 1, wherein the electrodes are substantially planar and comprise a respective bottom portion and a respective top portion, said bottom and top portions being foldable such that the bottom portion extends substantially perpendicularly to the top portion.

11. A sensor device according to claim 1, further comprising a light source for visually indicating low content in the container, said controller being operable to activate said light source to emit light in response to said alert signal indicating low content.

12. A serving system comprising a sensor device according to claim 1 and said container, wherein the electrodes of each respective pair of electrodes are provided on opposite sides of the container for measuring capacitance through the container.

13. A serving system comprising a sensor device according to claim 2, said serving system further comprising said container, wherein the electrodes of each respective pair of electrodes are provided on opposite sides of the container for measuring capacitance through the container, and wherein the pairs of electrodes are positioned apart from each other for measuring capacitance through different portions of the container.

14. A serving system comprising a sensor device according to claim 1, wherein the electrodes are attached directly onto the outside of the container.

15. A method of calibrating a serving system according to claim 12 for a specific type of content, comprising the steps of
for a plurality of different fill levels of the container operating the capacitance meter to record for each fill level reference values for the capacitance for each respective pair of electrodes,
and based on the recorded values prepare calibration data related to the type of container and/or to the type of content, such that the calibration data relates capacitance values to a contained content level for the specific type of container and/or to the type of content used for performing the method.

16. A computer readable storage medium encoded with instructions that, when executed on a processor, perform the method according to claim 15.
